(19) United States
(12) Patent Application Publication
(10) Pub. No.: US 2008/0104845 A1
(43) Pub. Date: May 8, 2008

(54) Apparatus and method for manufacturing spherical bearing assembly

(75) Inventors: Dai-Gil Lee, Yuseong-ku (KR); Byung-Chul Kim, Yuseong-ku (KR)

Correspondence Address: NATH & ASSOCIATES, 112 South West Street, Alexandria, VA, 22314, US

(73) Assignees: KOREA ADVANCED INSTITUTE OF SCIENCE AND TECHOLOGY, Daejeon (KR); MICROTECH SYSTEM, INC., Gyeonggi-do (KR)

(21) Appl. No.: 11/976,373

(22) Filed: Oct. 24, 2007

(30) Foreign Application Priority Data
Nov. 3, 2006 (KR) 10-2006-108245

(51) Int. Cl. B21D 53/10; B29C 45/14

(52) U.S. Cl. 29/898.043; 425/129.1

(57) ABSTRACT

A spherical bearing assembly manufacturing apparatus and its manufacturing method is disclosed. The spherical bearing that houses and supports a spherical journal is manufactured with fiber reinforced composite as a material. The spherical bearing assembly manufacturing apparatus consists of a mold, plunger, and first and second grippers. The mold has a cavity for molding fiber reinforced composite into a spherical bearing, and a first press surface for supporting fiber reinforced composite, and a first guide hole communicated with the cavity. The plunger has a second press surface for molding the fiber reinforced composite housed in the cavity into a spherical bearing, and a second guide hole formed in the center of the second press surface. In the first gripper is formed a hole in which the edge on one end of the spherical journal is housed. In the second gripper is formed a recessed portion in which the edge on the other end of the spherical journal is housed.

This application claims priority to Korean Patent Application No. 2006-108245, filed on Nov. 3, 2006, in the Korean Intellectual Property Office, the entire contents of which are hereby incorporated by reference.

### BACKGROUND OF THE INVENTION

1. Field of the Invention

The present invention relates to an apparatus and method for manufacturing a spherical bearing assembly, more specifically, to an apparatus and method for manufacturing a spherical bearing assembly whereby a spherical bearing that houses and supports a spherical journal is manufactured with fiber reinforced composite as a material.

2. Description of the Related Art

A spherical bearing is a mechanical element that supports a spherical journal and is used in various machines and apparatuses. A spherical bearing assembly is constructed by combination of a spherical bearing and a spherical journal, and is also used as a ball joint which connects two mechanical elements to enable them to move freely within a predetermined angle range.

As an example, U.S. Pat. No. 5,762,424 discloses a spherical bearing assembly comprising a housing, which is an irrotational member, a glass fiber composite socket, a metal or glass fiber composite ball, composite bearing sleeves, and a rotating axis. The spherical bearing assembly disclosed in this document has a problem that a slot for combining the socket to the housing should be precisely processed. Another problem is that possibility of difference in productivity is high due to a large number of parts provided in the spherical bearing assembly.

In addition, U.S. Pat. No. 6,209,206 discloses a composite spherical bearing in which a resinous epoxy composite provided with self-lubricating material on the inner surface and a glass-fiber epoxy composite ball having self-lubricating material coated on the outer surface are assembled. The ball is cut in the radial direction to be divided into two before being mounted on the outer race one by one. The composite spherical bearing disclosed in this document has a problem in that bearing clearance varies with the tolerance of the axis that goes through the ball to be assembled, and if tolerance cannot be adjusted precisely, slip occurs between the axis and ball in an unlubricated condition. Moreover, glass fiber composite has a drawback in that although it has excellent shock absorbability and strength, its heat distortion is greater compared with carbon fiber composite, and since the lubrication performance of glass fiber is not excellent, its friction coefficient increases severely if the self-lubricating layer of the surface is abraded.

### SUMMARY OF THE INVENTION

The present invention is to solve such problems of the prior art as mentioned above with an object to provide an apparatus and method for manufacturing a spherical bearing assembly whereby productivity can be improved as the manufacturing process becomes simple, because the spherical bearing that houses and supports the spherical journal is manufactured with fiber reinforced composite as a material by net shape manufacturing or resin transfer molding.

Another object of the present invention is to provide an apparatus and method for manufacturing a spherical bearing assembly whereby the bearing clearance between a spherical bearing and a spherical journal can be maintained uniformly and accurately.

Yet another object of the present invention is to provide an apparatus and method for manufacturing a spherical bearing assembly whereby a self-lubricating layer having a self-lubricating characteristic can be formed easily.

A further object of the present invention is to provide an apparatus and method for manufacturing a spherical bearing assembly whereby a structure can be configured monolithically in a spherical bearing that is net-shape manufactured or resin-transfer molded so as to house and support a spherical journal with fiber reinforced composite as a material.

In accordance with one aspect the present invention, there is provided an apparatus for manufacturing a spherical bearing assembly, which consists of a spherical journal having a spherical surface and a bearing surface that houses and supports the spherical journal, and in which said spherical bearing is provided with fiber reinforced composite, the apparatus comprising: a mold which includes a cavity for molding said fiber reinforced composite into said spherical bearing by housing said spherical journal and said fiber reinforced composite, a first press surface protruded in the inner surface of said cavity so as to support said fiber reinforced composite, and a first guide hole formed in the center of said first press surface so as to communicate with said cavity; a plunger, which is provided with a second press surface for compressing said fiber reinforced composite housed in the cavity of said mold to be molded into said spherical bearing, and in which a second guide hole is formed in the center of said second press surface; a first gripper, in which a recessed portion for housing the edge on one end of said spherical journal is formed, and which is inserted into said second guide hole and moves sliding along its inner circumference; and a second gripper, in which a recessed portion for housing the edge on the other end of said spherical journal is formed, and which is inserted into said first guide hole and moves sliding along its inner circumference, wherein said spherical journal is arranged in the cavity of said mold while it is assembled to said first gripper and second gripper, and after filling said fiber reinforced composite between said spherical journal and said cavity, said fiber reinforced composite is molded into said spherical bearing to house said spherical journal by mold-closing of said mold and plunger.

In accordance with another aspect of the present invention, there is provided a method for manufacturing a spherical bearing assembly comprising the steps of: preparing a preassembly by housing the edges on both ends of a spherical journal in the respective recessed portions of first and second grippers in such a way that a spherical surface of the spherical journal is exposed; attaching fiber reinforced composite made of a plurality of reinforced fibers and the matrix impregnated in these reinforced fibers on the spherical surface of said spherical journal and the respective outer surfaces of the first and second grippers; arranging said preassembly, that has said fiber reinforced composite attached, in a cavity of a mold; heating said matrix so as to have fluidity; molding said fiber reinforced composite into a spherical bearing that has a bearing surface spherically paired with the spherical surface of said spherical journal by mold-closing said mold and plunger so as to compress said fiber reinforced composite on said mold; taking out said preassembly with the molded spherical bearing from the cavity of said mold by mold-opening said mold and plunger; and separating said first and second grippers from both ends of said spherical journal.

### BRIEF DESCRIPTION OF THE DRAWINGS

These and other objects, features, and advantages of preferred embodiments of the present invention will be more fully described in the following detailed description, taken in conjunction with the accompanying drawings. In the drawings:

FIG. 1 is a sectional view showing a spherical bearing assembly manufactured according to a first embodiment of the present invention;

FIG. 2 is an exploded sectional view showing a manufacturing apparatus of the spherical bearing assembly according to the first embodiment of the present invention;

FIG. 3 is a sectional view showing a preassembly in which the spherical journal is clamped by first and second grippers and a coupling device in the manufacturing apparatus shown in FIG. 2;

FIG. 4 is a sectional view showing the configuration of the preassembly having fiber reinforced composite attached thereto in the manufacturing apparatus illustrated in FIG. 3;

FIG. 5 is a sectional view showing the configuration of a mold and plunger in which the preassembly is assembled in the manufacturing apparatus illustrated in FIG. 4;

FIG. 6 is a sectional view showing the process of compression-molding of fiber reinforced composite by mold-closing of the mold and plunger in the manufacturing apparatus illustrated in FIG. 5;

FIG. 7 is a sectional view showing a condition in which the spherical bearing assembly according to the first embodiment of the present invention is taken out by mold-opening of the mold and plunger in the manufacturing apparatus illustrated in FIG. 6;

FIG. 8 is a flow chart showing the manufacturing process of the spherical bearing assembly by using the manufacturing apparatus of the spherical bearing assembly according to the first embodiment of the present invention;

FIG. 9 is a sectional view showing a spherical bearing assembly manufactured according to a second embodiment of the present invention;

FIG. 10 is a sectional view showing the configuration of a preassembly that has fiber reinforced composite attached thereto in the manufacturing apparatus illustrated in FIG. 9;

FIG. 11 is a sectional view showing the process of compression-molding of fiber reinforced composite by mold-closing of the mold and plunger of the manufacturing apparatus illustrated in FIG. 10;

FIG. 12 is a sectional view showing a spherical bearing assembly manufactured according to a third embodiment of the present invention;

FIG. 13 is a sectional view showing the configuration of a preassembly that has a reinforced preform of fiber reinforced composite attached thereto in the manufacturing apparatus illustrated in FIG. 12;

FIG. 14 is a sectional view showing the process of compression-molding the reinforcement fiber preform of fiber reinforced composite by mold-closing of the mold and plunger in the manufacturing apparatus illustrated in FIG. 13;

FIG. 15 is a flow chart showing the manufacturing process of the spherical bearing assembly by using the manufacturing apparatus of the spherical bearing assembly according to the third embodiment of the present invention;

FIG. 16 is a sectional view showing a spherical bearing assembly manufactured by a fourth embodiment of the present invention;

FIG. 17 is a sectional view showing the process of compression-molding of fiber reinforced composite by mold-closing of the mold and plunger in the manufacturing apparatus illustrated in FIG. 16; and

FIG. 18 is a sectional view showing the configuration in which the spherical bearing is taken out by mold-opening of the mold and plunger in the manufacturing apparatus illustrated in FIG. 17.

### DETAILED DESCRIPTION OF THE INVENTION

An apparatus and method for manufacturing a spherical bearing assembly according to the preferred embodiments of the present invention with reference to the accompanying drawings will be described in detail below.

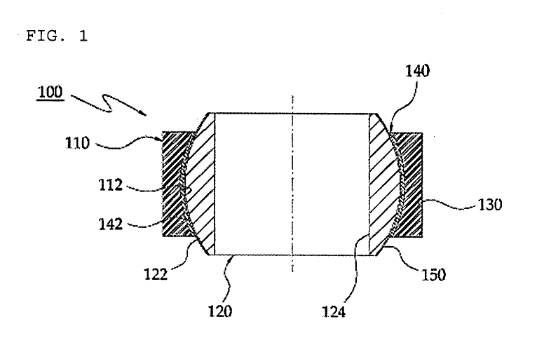

First, FIG. 1 shows a spherical bearing assembly manufactured according to a first embodiment of the present invention. Referring to FIG. 1, a spherical bearing assembly 100 of the first embodiment consists of a spherical bearing 110 and a spherical journal 120. An spherical bearing surface 112 is formed on the inner surface of the spherical bearing 110. The spherical journal 120 may be composed of metal. The spherical journal 120 is housed in the spherical bearing 110, and the outer surface of the spherical journal 120 is formed by a spherical surface 122 that is spherically paired with the bearing surface 112 of the spherical bearing 110. An axis hole 124 by which mechanical elements (not shown) such as an axis and rod are inserted is formed in the center of the spherical journal 120.

Referring to FIG. 4, the spherical bearing 110 is composed of fiber reinforced composite 130, which is composed of a plurality of prepregs (sheet-form carbon fibers impregnated with resin) 132 laminated in a multi-layer. The prepreg 132 is composed of a plurality of reinforced fibers 134, and matrixes 136 which are impregnated in reinforced fibers 134 to fix these reinforced fibers 134 and hardened to B-stage (half hardening state). The reinforced fibers 134 can be composed of carbon fiber, glass fiber, Kevlar fiber™ (available from Du Pont Co., in USA), etc., and the matrix 136 can be composed of thermosetting resin such as phenolic resin, epoxy resin, polyester resin, and polyimide. The prepreg 132 is manufactured in a form of laminate or sheet by hardening the matrix 136 to B-stage after arraying the reinforced fibers 134 and impregnating the matrix 136 in the reinforced fibers 134.

Referring again to FIG. 1, a self-lubricating layer 140 having a self-lubricating characteristic is formed on the bearing surface 112 of the spherical bearing 110. The self-lubricating layer 140 may be composed of self-lubricating particles 142 or a self-lubricating film. The self-lubricating particles 142 can be composed variously of thermoplastic polymers such as polytetrafluoroethylene (PTFE) and polyetheretherketone (PEEK), or molybdenum oxide (MOS₂), or carbon black, having a low friction coefficient and a nanometer or micrometer size. The self-lubricating film may be composed of thermosetting polymers such as PTFE and PEEK. The self-lubricating layer 140 decreases the friction coefficient between the bearing surface 112 and the spherical journal 120 of the spherical bearing 110. Metal coating 150 is coated on the surface of the spherical journal 120 by electroplating and plasma spray coating and the metal coating 150 may be formed of chrome (Cr). The surface roughness and sliding contact property of the spherical journal 120 are improved by metal coating 150.

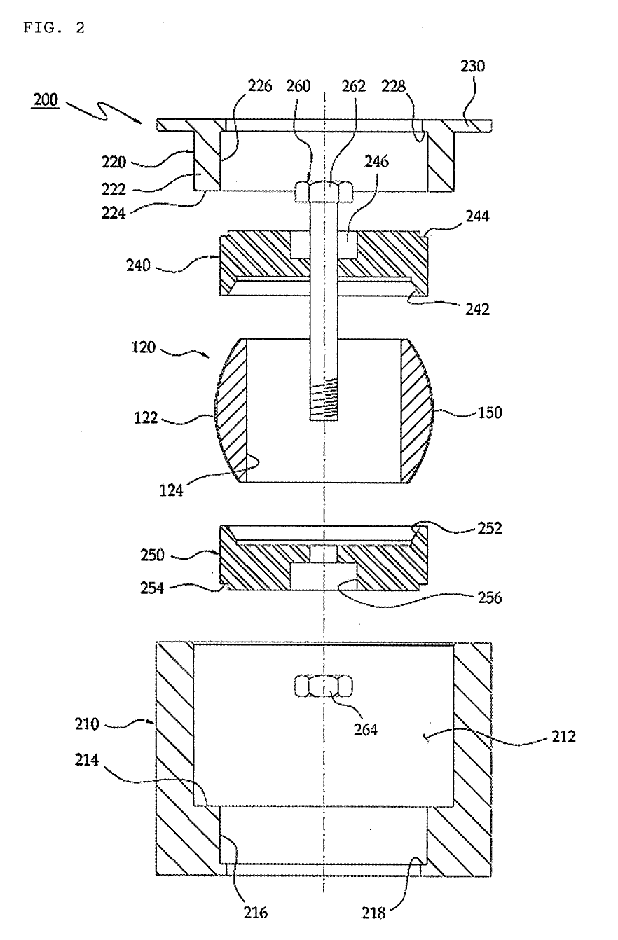

FIGS. 2 to 7 show a manufacturing apparatus of the spherical bearing assembly according to the first embodiment of the present invention. Referring to FIG. 2, the manufacturing apparatus 200 of the first embodiment includes a mold 210 and a plunger 220. In the center of the mold 210 is formed a cavity 212, and a first press surface 214 is formed to protrude toward the center on the inner surface of the cavity 212. A first guide hole 216 communicating with the cavity 212 is formed in the center of the first press surface 214. A first stepped portion 218 is formed on the inner surface of the first guide hole 216. The plunger 220 has a sleeve 222 that is inserted to fit in the cavity 212 of the mold 210. A second press surface 224 is formed at the bottom end of the sleeve 222, and a second guide hole 226 is formed in the sleeve 222. A second stepped portion 228 is formed on the inner surface of the second guide hole 226. At the top end of the sleeve 222 is formed a flange 230 so as to support the sleeve 222 on the top surface of the mold 210.

The manufacturing apparatus 200 of the first embodiment is composed of a first gripper 240, a second gripper 250 and a coupling device 260. The first gripper 240 and the second gripper 250 are composed identically. Recessed portions 242 and 252 in which the edges of both ends of the spherical journal 120 are housed are formed respectively on one surface of the first and second grippers 240 and 250. A third stepped portion 244 to be supported on the second stepped portion 228 is formed on the other surface of the first gripper 240, and a fourth stepped portion 254 to be supported on the first stepped portion 218 is formed on the other surface of the second gripper 250. A first counterbored hole 246 is formed in the center of the first gripper 240, and a second counterbored hole 256 that is aligned with the center of the first counterbored hole 246 is formed in the center of the second gripper 250. The first and second grippers 240 and 250 are fastened each other by the coupling device 260 that consists of a bolt 264 inserted into the first and second counterbored holes 246 and 256 and a nut 264 fastened to the bolt 262. The respective first and second counterbored holes 246 and 256 of the first and second grippers 240 and 250 are formed by counter boring so as to seat the head of the bolt 262 and the nut 264.

The first and second grippers 240 and 250 are inserted slidably to fit in the first guide hole 216 and the second guide hole 226 of the plunger 220. A preassembly 270 which is made by clamping the spherical journal 120 by the first gripper 240, the second gripper 250 and the coupling device 260 is housed in the cavity 212 of the mold 210. The sleeve 222 of the plunger 220 is inserted to fit in the gap formed between the inner surface of the cavity 212 and the outer surface of the first and second grippers 240 and 250.

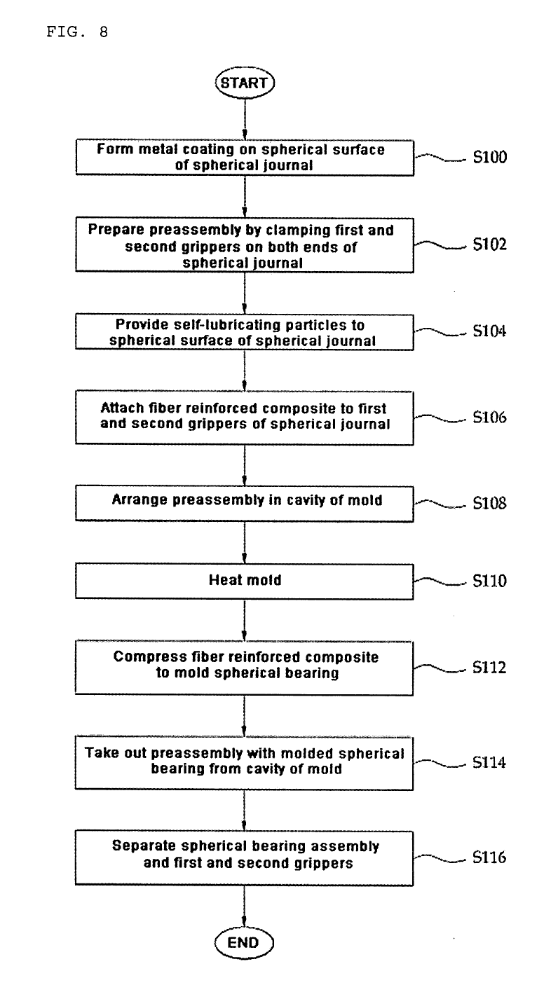

Below will be described the manufacturing method of a spherical bearing assembly by the manufacturing apparatus of the first embodiment having such configuration based on FIG. 8.

Referring to FIGS. 1 to 3, the worker coats the spherical surface 122 of the spherical journal 120 with metal coating 150 of chrome, for example (S100). The coating process of metal coating 150 may be omitted as necessary. The worker prepares the preassembly 270 by clamping the first and second grippers 240 and 250 at both ends of the spherical journal 120 by fastening the coupling device 260 in such a way that the spherical surface 122 of the spherical journal 120 is exposed (S102).

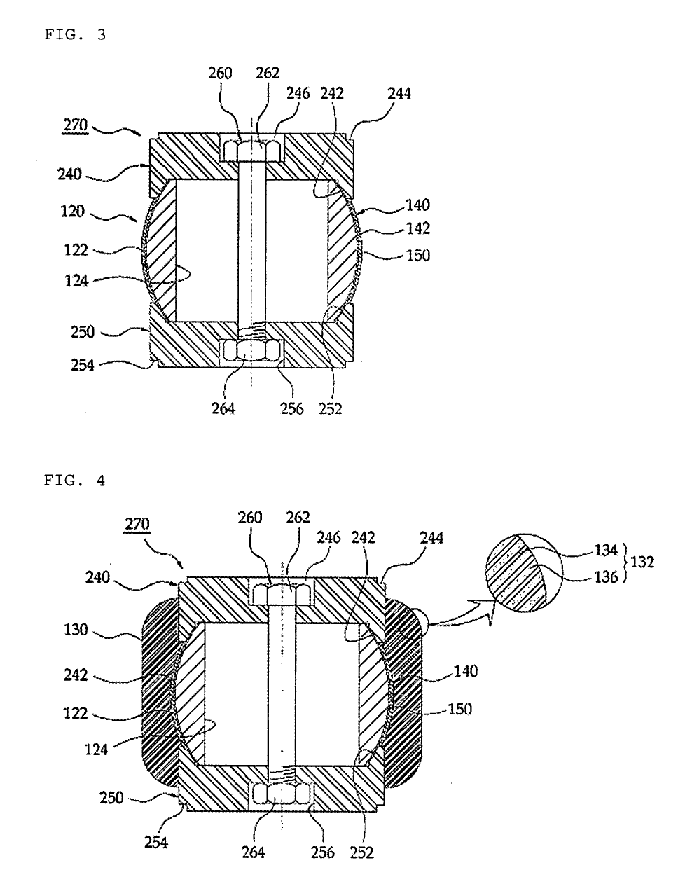

As shown in FIG. 3, the worker houses the edge on one end of the spherical journal 120 in the recessed portion 242 of the first gripper 240, and houses the edge on the other end of the spherical journal 120 in the recessed portion 252 of the second gripper 250. After inserting the bolt 262 by passing it through the first counterbored hole 246 of the first gripper 240, the axis hole 124 of the spherical journal 120 and the second counterbored hole 256 of the second gripper 250, fasten the nut 264 to the male screw of the bolt 262 which is to be located in the second counterbored hole 256 of the second gripper 250. When both ends of the spherical journal 120 are housed in the recessed portions 242 and 252 of the first and second grippers 240 and 250, the outer surface edges of the spherical journal 120 are covered by the first and second grippers 240 and 250. Accordingly, it is possible to easily adjust the surface area of the spherical surface 122 of the spherical journal 120 that is spherically paired with the bearing surface 112 of the spherical bearing 110 in the spherical bearing assembly 100.

After preparing the preassembly 270 by assembling the spherical journal 120, the first gripper 240, the second gripper 250 and the coupling device 260, the worker forms a self-lubricating layer 140 by providing self-lubricating particles 142 or self-lubricating film to the spherical surface 122 (S104). The worker coats the spherical surface 122 of the spherical journal 120 with self-lubricating particles 142 of thermosetting polymer such as PTFE and PEEK, or molybdenum oxide or carbon black, or forms a self-lubricating layer by cladding the spherical surface 122 of the spherical journal 120 with mixture made by mixing self-lubricating particles 142 and binder. The self-lubricating film is formed by melting thermosetting polymer and coating it on the spherical surface 122 of the spherical journal 120 or by attaching the film itself. Meanwhile, forming the self-lubricating layer 140 may be omitted as necessary.

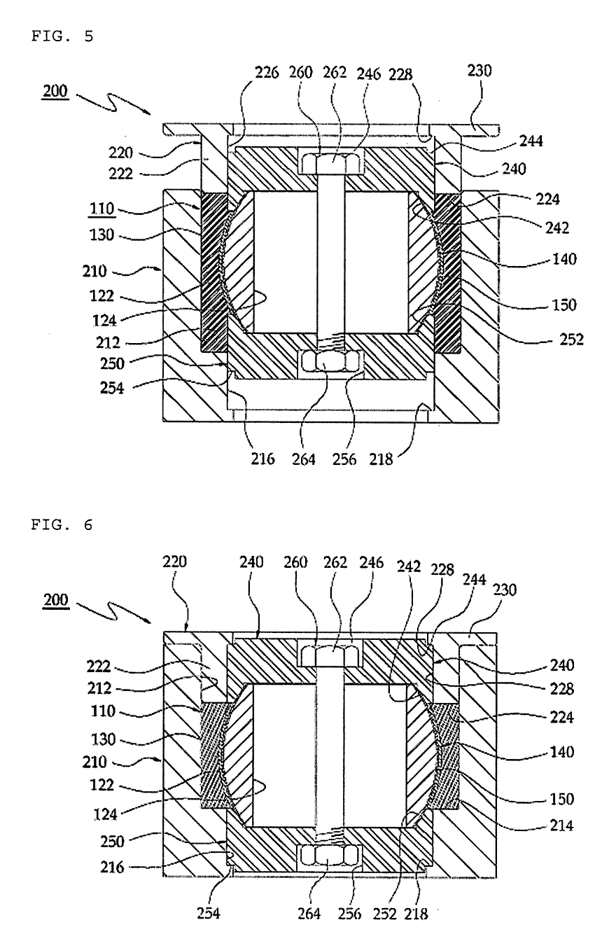

Referring to FIG. 4 and FIG. 5, fiber reinforced composite 130 is attached to the spherical surface 122 of the spherical journal 120 and the outer surface of the first and second grippers 240 and 250 (S106), and the preassembly 270 that has fiber reinforced composite 130 attached thereto, is arranged in the cavity 212 of the mold 210 (S108). When the worker inserts the preassembly 270 into the cavity 212 of the mold 210, the bottom end of the fiber reinforced composite 130 is supported on the first press surface 214 of the mold 210, and the top end of the fiber reinforced composite 130 is arranged almost in correspondence with the top surface of the mold 210. And the first gripper 240 is protruded above the mold 210. Meanwhile, after a preassembly 270 that has the fiber reinforced composite 130 not attached is arranged in the cavity 212 of the mold 210, the fiber reinforced composite 130 may be filled between the spherical surface 122 of the spherical journal 120 and the cavity 212 of the mold 210.

After arranging the preassembly 270 in the cavity 212 of the mold 210, the worker heats the mold 210 by a heating device to impart fluidity to the matrix 136 of the fiber reinforced composite 130 (S110). The mold 210 is heated up by the operation of the heating device to the temperature at which the matrix 136 exhibits fluidity. As the temperature of the mold 210 increases, the matrix 136 having fluidity is filled in the interface of the reinforced fibers 134, and when the mold 210 is cooled, the matrix 136 is hardened. Also, the reinforced fibers 134, self-lubricating particles 142 or self-lubricating film are cross linked firmly with the matrix 136.

Referring to FIG. 6, the worker compresses the fiber reinforced composite 130 located in the cavity 212 between the mold 210 and the first gripper 240 by the plunger 220 to mold the spherical bearing 110 (S112). The worker inserts the sleeve 222 of the plunger 220 between the inner surface of the mold 210 and the outer surface of the first gripper 240, and lowers the plunger 220. The plunger 220 may be mounted on a ram (not shown) of a conventional press for operation. When the sleeve 222 of the plunger 220 is lowered, the fiber reinforced composite 130 is pressed by the second press surface 224. The first gripper 240 is inserted into the second guide hole 226 of the plunger 220 to be guided, and the third stepped portion 244 of the first gripper 240 is stopped by the second stepped portion 228 of the plunger 220 to be supported.

Also, when the plunger 220 continues to be lowered while the third stepped portion 244 of the first gripper 240 is stopped by the second stepped portion 228 of the plunger 220, the preassembly 270 is forcibly inserted into the cavity 212 together with the plunger 220. The second gripper 250 is guided along the first guide hole 216 of the mold 210 to allow entry of the preassembly 270. The fourth stepped portion 254 of the second gripper 250 is supported on the first stepped portion 218 of the mold 210, and the flange 230 of the plunger 220 is supported on the top surface of the mold 210 to complete mold-closing. Reinforced fibers 134 that are softened with heat and pressure imparted by mold-closing of the mold 210 and plunger 220 are consolidated to make the spherical bearing 110.

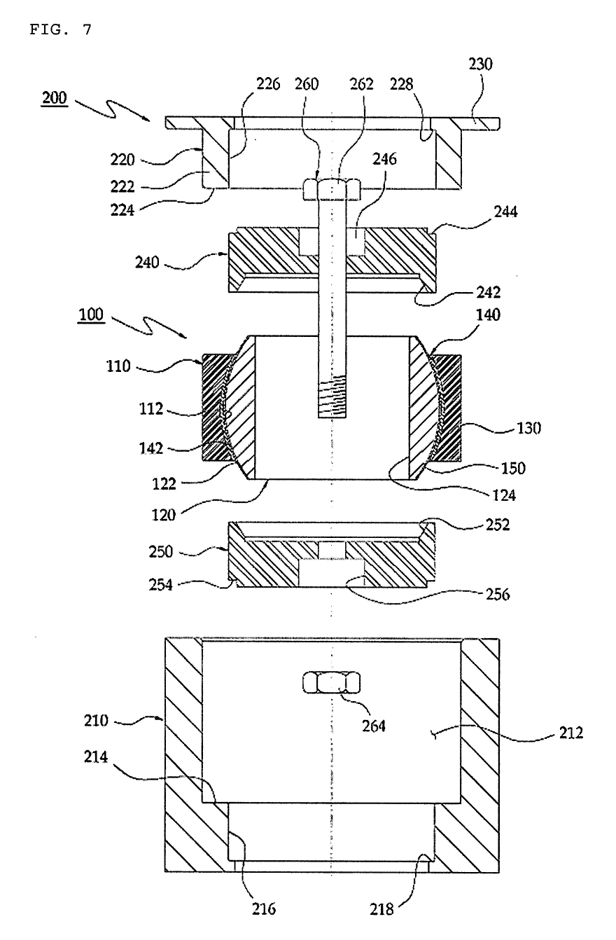

Referring to FIG. 7, after mold-opening of the mold 210 and plunger 220, the worker takes out the preassembly 270 with the molded spherical bearing 110 from the cavity 212 of the mold 210 (S114). Finally, by separating the spherical bearing assembly 100 of the first embodiment and the first and second grippers 240 and 250 (S116), the spherical bearing 100 of the first embodiment illustrated in FIG. 1 is completed.

Meanwhile, the coefficient of thermal expansion of fiber reinforced composite 130 is lower than that of the spherical journal 120 of metal. Accordingly, after hardening of the spherical bearing 110, the self-lubricating layer 140 formed on the spherical bearing surface 112 of the spherical bearing 110 at room temperature is peeled off from the spherical journal 120 of metal by its releasing property, and bearing clearance of a given size is accurately maintained between the spherical bearing 110 and the spherical journal 120. Like this, it is possible to easily and accurately manufacture the spherical bearing assembly 100 in which the spherical bearing 110 and the spherical journal 120 are assembled by net shape manufacturing that does not need additional processing by hot compression molding of fiber reinforced composite 130.

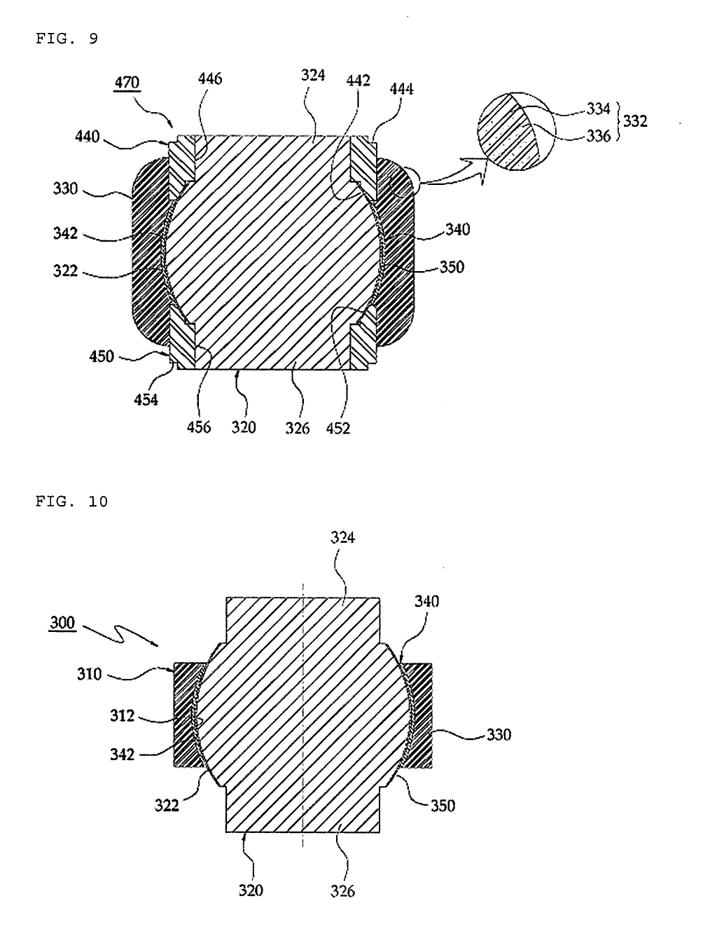

FIG. 9 shows a spherical bearing assembly which is manufactured according to the second embodiment of the present invention. Referring to FIG. 9, the spherical bearing assembly 300 of the second embodiment is composed of a spherical bearing 310 and a spherical journal 320. Since the spherical bearing 310, bearing surface 312, fiber reinforced composite 330, prepreg 332, reinforced fibers 334, matrix 336, self-lubricating layer 340 and metal coating 350 of the spherical bearing assembly 300 of the second embodiment are composed identically with the spherical bearing 110, bearing surface 112, fiber reinforced composite 130, prepreg 132, reinforced fibers 134, matrix 136, self-lubricating layer 140 and metal coating 150 of the spherical bearing assembly 100 of the first embodiment, detailed description of its structure and action is omitted. The outer surface of the spherical journal 320 is formed on a spherical surface 322 that is spherically paired with the bearing surface 312 of the spherical bearing 310. The first axis portion 324 and second axis portion 326 are formed monolithically on both ends of the spherical journal 320.

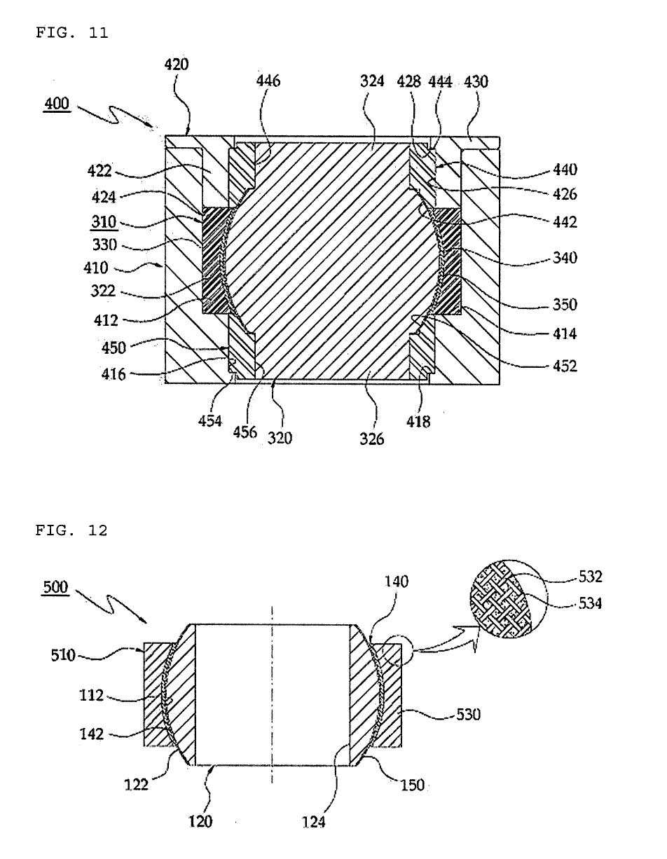

FIG. 10 and FIG. 11 show a spherical bearing assembly manufacturing apparatus according to the second embodiment of the present invention. Referring to FIG. 10 and FIG. 11, the manufacturing apparatus 400 of the second embodiment comprises a mold 410, a plunger 420, a first gripper 440 and a second gripper 450. Since the mold 410, cavity 412, first press surface 414, first guide hole 416, first stepped portion 418, plunger 420, sleeve 422, second press surface 424, second guide hole 426, second stepped portion 428 and flange 430 of the manufacturing apparatus of the second embodiment are composed identically with the mold 210, cavity 212, first press surface 214, first guide hole 216, first stepped portion 218, plunger 220, sleeve 222, second press surface 224, second guide hole 226, second stepped portion 228 and flange 230 of the manufacturing apparatus 200 of the first embodiment, detailed description of its structure and action is omitted.

The first gripper 440 and second gripper 450 are composed identically. Recessed portions 442 and 452 in which the edges on both sides of the spherical journal 320 are housed are formed respectively on one surface of the first and second grippers 440 and 450, and the third and fourth stepped portions 444 and 454 on which the first and second stepped portions 418 and 428 are stopped to be supported are formed respectively on the other surface of the grippers 440 and 450. The first through hole 446 into which the first axis portion 324 of the spherical journal 320 is inserted to be assembled is formed in the center of the first gripper 440, and the second through hole 456 into which the second axis portion 326 of the spherical journal 320 is inserted to be assembled is formed in the center of the second gripper 450.

The manufacturing method of the spherical bearing assembly 300 of the second embodiment by the manufacturing apparatus 400 of the second embodiment having such configuration will be described. While the worker inserts the first axis portion 324 of the spherical journal 320 into the first through hole 446 of the first gripper 440 to assemble, he houses the edge on one end of the spherical journal 320 in the recessed portion 442. Also, while inserting the second axis portion 326 of the spherical journal 320 into the second through hole 456 of the second gripper 450, he houses the edge on the other end of the spherical journal 320 in the recessed portion 452. The spherical surface 322 of the spherical journal 320 is exposed between the first and second grippers 440 and 450 that are assembled on both ends of the spherical journal 320.

Next, when a preassembly 470 in which the spherical journal 320 and the first and second grippers 440 and 450 are assembled is prepared, the worker provides self-lubricating particles 342 or self-lubricating film to form a self-lubricating layer 340 on the spherical surface 322 of the spherical journal 320. The fiber reinforced composite 330 is attached to the spherical surface 322 of the spherical journal 320 and the outer surface of the first and second grippers 440 and 450, and a preassembly 470 that has fiber reinforced composite 330 attached is arranged in the cavity 412 of the mold 410. The mold 410 is heated to impart fluidity to the matrix 336 of the fiber reinforced composite 330. The mold 410 and plunger 420 are mold-closed and the fiber reinforced composite 330 is compressed to complete a spherical bearing assembly 300 of the second embodiment illustrated in FIG. 10.

FIG. 12 shows a spherical bearing assembly manufactured by a third embodiment of the present invention. Referring to FIG. 12, since the configuration of the spherical bearing assembly 500 of the third embodiment is basically the same as the configuration of the spherical bearing assembly 100 of the first embodiment, symbols the same as those of the components of the spherical bearing assembly 100 of the first embodiment are given to the components of the spherical bearing assembly 500 of the third embodiment, and detailed description thereof is omitted. The fiber reinforced composite 530 of the spherical bearing assembly 500 of the third embodiment is composed of reinforcement fiber preform 532 and matrix 534.

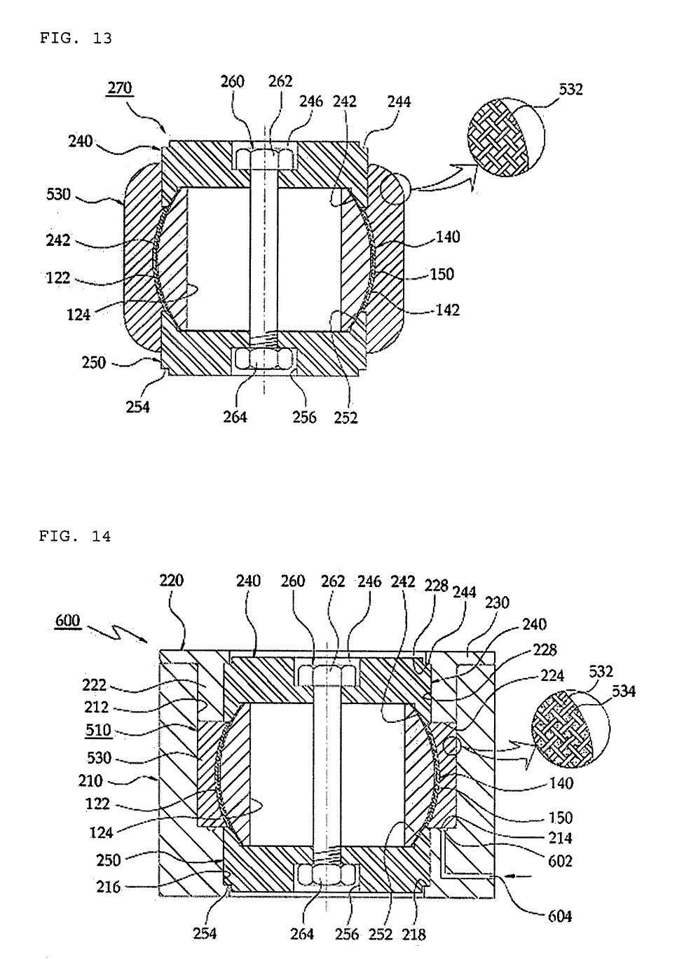

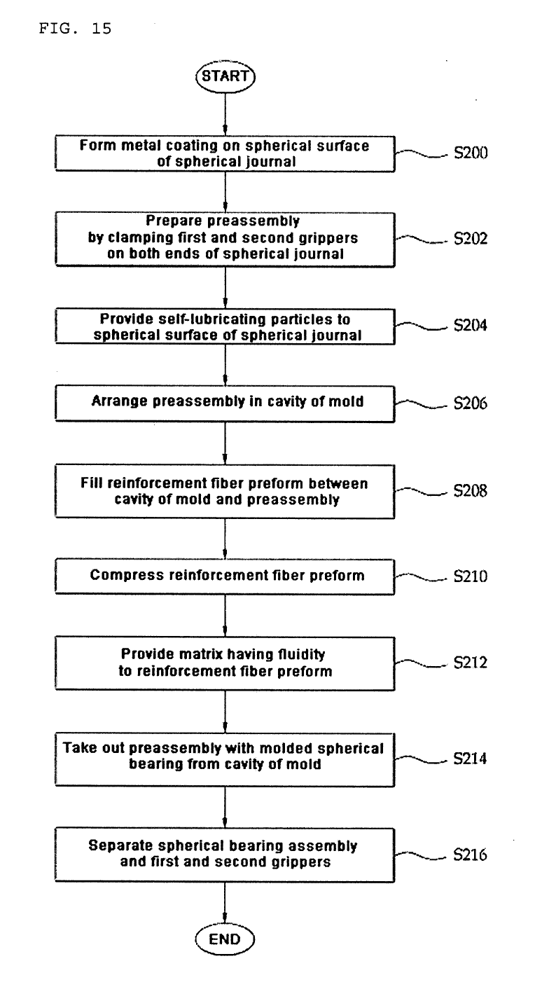

FIG. 13 and FIG. 14 show a spherical bearing assembly manufacturing apparatus according to the third embodiment of the present invention. Referring to FIG. 13 and FIG. 14, since the configuration of the manufacturing apparatus 600 of the third embodiment is basically the same as the configuration of the manufacturing apparatus 200 of the first embodiment, symbols the same as those of the components of the manufacturing apparatus 200 of the first embodiment are given to the components of the manufacturing apparatus 600 of the third embodiment, and detailed description thereof is omitted. An annular runner 602 is formed on the first press surface of the mold 210 and a gate 604 that communicates with the runner 602 is formed on the outer surface of the mold 210.

The manufacturing method of the third embodiment for manufacturing a spherical bearing assembly 500 by the manufacturing apparatus 600 of the third embodiment is described based on FIG. 15.

Referring to FIG. 13 as well, first the worker coats the spherical surface 122 of the spherical journal 120 with metal coating 150 (S200). The worker prepares a preassembly 270 by fastening the first and second grippers 240 and 250 at both ends of the spherical journal 120 by the coupling device 260 in such a way that the spherical surface 122 of the spherical journal 120 is exposed (S202). After preparing the preassembly 270 in which the spherical journal 120, the first gripper 240, the second gripper 250 and the coupling device 260 are assembled, the worker provides self-lubricating particles 142 or self-lubricating film to form the self-lubricating layer 140 on the spherical surface 122 of the spherical journal 120 (S204).

Referring to FIG. 14, the worker arranges the preassembly 270 in the cavity 212 of the mold 210. The worker fills a reinforcement fiber preform 532 between the cavity 212 of the mold 210 and the preassembly 270 (S208). After filling the reinforcement fiber preform 532, the mold 210 and plunger 220 are mold-closed to compress the reinforcement fiber preform 532 (S210). A matrix 534 having fluidity is supplied to the reinforced preform 532 through the gate 604 of the mold 210 (S212). The matrix 534 having fluidity that is injected in the gate 604 of the mold 210 is supplied uniformly to the reinforcement fiber preform 532 through the runner 602 to be filled in the interface of the reinforced fibers of the reinforcement fiber preform 532, and the reinforced fibers and the self-lubricating layer 140 are cross linked firmly with the matrix 534.

After mold-opening of the mold 210 and plunger 220, the worker takes out the preassembly 270 with the molded spherical bearing 510 from the cavity 212 of the mold 210 (S214). Finally, by separating the spherical bearing assembly 500 of the third embodiment and the first and second grippers 240 and 250 (S216), the spherical bearing assembly 500 of the third embodiment is completed.

Like this, it is possible to manufacture the spherical bearing assembly 500 of the third embodiment easily and accurately by compressing the reinforcement fiber preform 532 by the mold 210 and plunger 220, and supplying the matrix 534 having fluidity to the reinforcement fiber preform 532 to mold the spherical bearing 110 of fiber reinforced composite 130 by resin transfer molding. Meanwhile, in the manufacturing apparatus 600 of the third embodiment, it is possible to manufacture the spherical bearing assembly 300 of the second embodiment by identical application of the runner 602 and gate 604 also to the manufacturing apparatus 400 of the second embodiment.

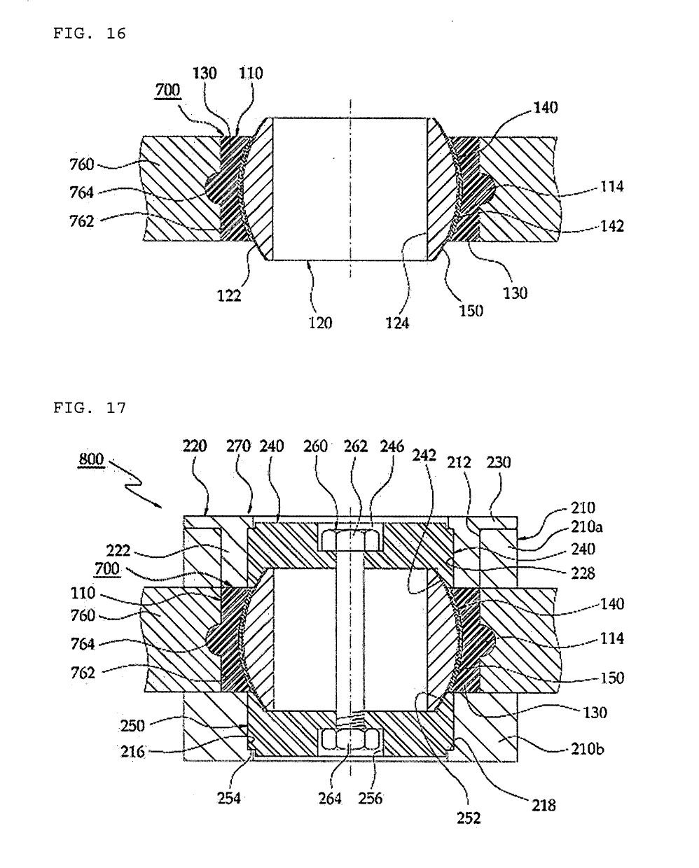

FIG. 16 shows a spherical bearing assembly manufactured according to a fourth embodiment of the present invention. Referring to FIG. 16, since the configuration of the spherical bearing assembly 700 of the fourth embodiment is basically the same as the configuration of the spherical bearing assembly 100 of the first embodiment, symbols the same as those of the components of the spherical bearing assembly 100 of the first embodiment are given to the components of the spherical bearing assembly 700 of the fourth embodiment, and detailed description thereof is omitted.

The spherical bearing assembly 700 manufactured according to the fourth embodiment is provided with a structure 760 which is assembled on the outer surface of the spherical bearing 110. The structure 760 can be mounted on various mechanical apparatuses and devices for installation of the spherical bearing assembly 700. The structure 760 has an insert hole 762 into which the spherical bearing assembly 700 is inserted for assembling. The structure 760 can be composed of various parts such as a connecting rod, housing and plate.

A plurality of recesses 764 are formed on the inner surface of the insert hole 762 of the structure 760 that is in contact with the outer surface of the spherical bearing 110, and a plurality of bosses 114 that are inserted into these recesses 764 are formed on the outer surface. The recesses 764 of the structure 760 can be substituted with an embossed or coarse surface. A rough surface of the structure 760 can be formed by sand blasting or coarse cutting.

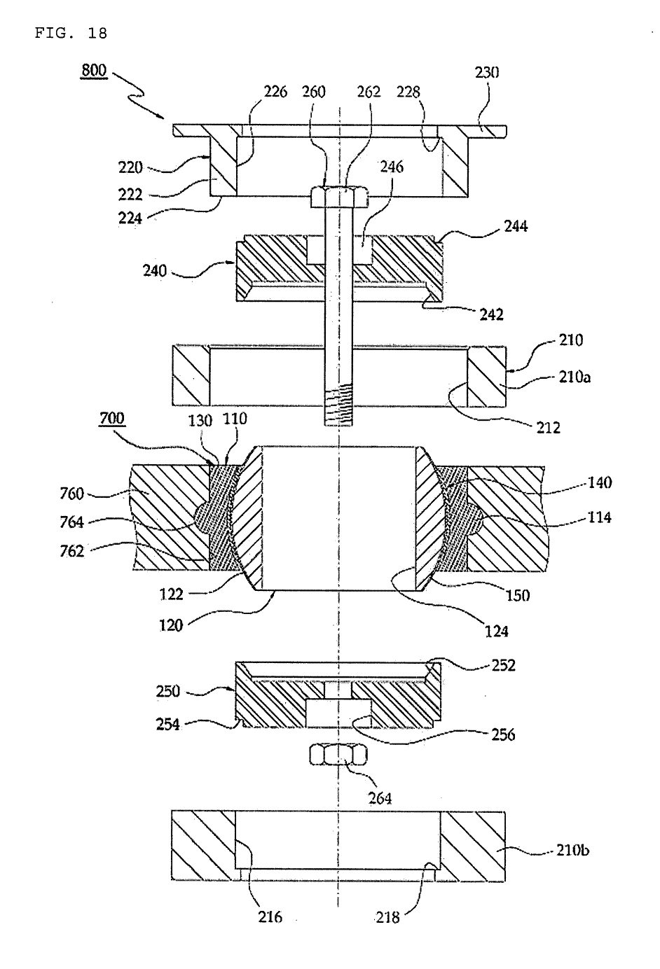

FIG. 17 and FIG. 18 show a spherical bearing assembly manufacturing apparatus according to the fourth embodiment of the present invention. Referring to FIG. 17 and FIG. 18, since the configuration of the manufacturing apparatus 800 of the fourth embodiment is basically the same as the configuration of the manufacturing apparatus of the first embodiment, symbols the same as those of the components of the manufacturing apparatus 200 of the first embodiment are given the components of the manufacturing apparatus 800 of the fourth embodiment, and detailed description thereof is omitted. The mold 210 is composed of an upper mold 210a and a lower mold 210b that can be separated up and down. The cavity 212 is formed in the center of the upper mold 210a.

After preparing the lower mold 210b while the upper mold 210a and lower mold 210b of the mold 210 are separated, the worker arranges the structure 760 on the top surface of the lower mold 210b with the center of the lower mold and the center of the insert hole 762 of the structure 760 aligned. The upper mold 210a on the top surface of the structure 760 is arranged with the cavity of the upper mold 210a and the center of the insert hole 762 aligned.

The worker prepares by stacking the lower mold 210b, the structure 760 and the upper mold 210a in sequence, with the insert hole 762 of the structure 760 and the center of the cavity 212 aligned. After arranging the preassembly 270 that has the fiber reinforced composite 130 attached in the cavity 212 of the mold 210, the spherical bearing 110 is molded by compressing the fiber reinforced composite 130 by mold-closing of the mold 210 and plunger 220. The fiber reinforced composite 130 compressed during molding of the spherical bearing 110 is filled in the recesses 764 of the structure 760, and the fiber reinforced composite 130 that is filled in the recesses 764 of the structure 760 is hardened to become bosses 114. The bosses 114 of the spherical bearing 110 are firmly joined in the recesses 764 of the structure 760 so as to prevent separation of the spherical bearing 110 and the structure 760.

Like this, as well as the spherical bearing 110 and spherical journal 120 of the spherical bearing assembly 700 manufactured according to the fourth embodiment are manufactured by net shape manufacturing, the spherical bearing 110 and the structure 760 can be assembled monolithically, so productivity of the spherical bearing assembly 700 can be improved greatly. The manufacturing method of the fourth embodiment for manufacturing the spherical bearing assembly 700 by the manufacturing apparatus 800 of the fourth embodiment can also be applied to the manufacturing method for manufacturing the spherical bearing assembly 300 of the second embodiment and the spherical bearing assembly 500 of the third embodiment.

As described above, by virtue of the spherical bearing assembly manufacturing apparatus and its manufacturing method according to the present invention, the spherical bearing that houses and supports the spherical journal is manufactured by net shape manufacturing or resin transfer molding with fiber reinforced composite as a material, making the manufacturing process simple, so that it is possible to improve productivity as well as uniformly and accurately maintain the bearing clearance between the bearing and the spherical journal. Another effect is that it is possible to easily form the self-lubricating layer having a self-lubricating characteristic and monolithically configure a structure on the spherical bearing by a single process.

What is claimed is:

1. An apparatus for manufacturing a spherical bearing assembly, which consists of a spherical journal having a spherical surface and a bearing surface that houses and supports the spherical journal, and in which said spherical bearing is provided with fiber reinforced composite, the apparatus comprising:
a mold which includes a cavity for molding said fiber reinforced composite into said spherical bearing by housing said spherical journal and said fiber reinforced composite, a first press surface protruded in the inner surface of said cavity so as to support said fiber reinforced composite, and a first guide hole formed in the center of said first press surface so as to communicate with said cavity;
a plunger, which is provided with a second press surface for compressing said fiber reinforced composite housed in the cavity of said mold to be molded into said spherical bearing, and in which a second guide hole is formed in the center of said second press surface;
a first gripper, in which a recessed portion for housing the edge on one end of said spherical journal is formed, and which is inserted into said second guide hole and moves sliding along its inner circumference; and
a second gripper, in which a recessed portion for housing the edge on the other end of said spherical journal is formed, and which is inserted into said first guide hole and moves sliding along its inner circumference,
wherein said spherical journal is arranged in the cavity of said mold while it is assembled to said first gripper and second gripper, and after filling said fiber reinforced composite between said spherical journal and said cavity, said fiber reinforced composite is molded into said spherical bearing to house said spherical journal by mold-closing of said mold and plunger.

2. The apparatus of claim 1, wherein a first stepped portion is formed on the inner surface of said first guide hole, and a second stepped portion is formed on the inner surface of said second guide hole, and a third stepped portion is formed in said first gripper so as to be supported on said second stepped portion, and a fourth stepped portion is formed in said second gripper so as to be supported on said first stepped portion.

3. The apparatus of claim 1, further comprising a bolt which passes through said first gripper, said spherical journal and said second gripper so as to clamp said spherical journal, said first gripper and said second gripper, and a nut which is fastened to said bolt.

4. The apparatus of claim 1, wherein said fiber reinforced composite consists of a reinforcement fiber preform and a matrix that is cross linked to the reinforcement fiber preform, and an annular runner is formed on the first press surface of said mold, and a gate that is communicated with said runner is formed on the outer surface of said mold, and said matrix having fluidity is supplied through said gate and runner so as to be impregnated in said reinforcement fiber preform.

5. The apparatus of claim 1, wherein first and second axis portions are formed respectively on both ends of said spherical journal, and first and second through holes into which said first and second axis portions are inserted are formed in the center of each of said first and second grippers.

6. The apparatus of claim 1, wherein said mold consists of an upper mold and lower mold which are separated up and down, and said spherical bearing is configured between said upper mold and lower mold so as to provide a monolithically assembled structure.

7. The apparatus of claim 6, wherein said structure has an insert hole for housing said spherical bearing and a plurality of recesses are formed on the inner surface of said hole for said fiber reinforced composite to be filled.

8. A method for manufacturing a spherical bearing assembly comprising the steps of:
preparing a preassembly by housing the edges on both ends of a spherical journal in the respective recessed portions of first and second grippers in such a way that a spherical surface of the spherical journal is exposed;
attaching fiber reinforced composite made of a plurality of reinforced fibers and the matrix impregnated in these reinforced fibers on the spherical surface of said spherical journal and the respective outer surfaces of the first and second grippers;
arranging said preassembly, that has said fiber reinforced composite attached, in a cavity of a mold;
heating said matrix so as to have fluidity;
molding said fiber reinforced composite into a spherical bearing that has a bearing surface spherically paired with the spherical surface of said spherical journal by mold-closing said mold and plunger so as to compress said fiber reinforced composite on said mold;
taking out said preassembly with the molded spherical bearing from the cavity of said mold by mold-opening said mold and plunger; and
separating said first and second grippers from both ends of said spherical journal.

9. The method of claim 8, further comprising a step for coating the spherical surface of said spherical journal with metal coating before the step for preparing said preassembly.

10. The method of claim 9, further comprising a step for applying a self-lubricating layer on the surface of said metal coating.

11. The method of claim 8, wherein said step for preparing the preassembly comprises a step for fastening the nut to the bolt after passing the bolt through said first gripper, said spherical journal and said second gripper so as to clamp said spherical journal, said first gripper and said second gripper.

12. The method of claim 8, wherein said step for preparing the preassembly comprises a step in which the respective first and second axis portions are formed on both ends of said spherical journal, a first through hole is formed in the center of said first gripper to insert said first axis portion, and a second through hole is formed in the center of said second gripper to insert said second axis portion.

13. A method for manufacturing a spherical bearing assembly comprising the steps of:
preparing a preassembly by housing the edges on both ends of a spherical journal in the respective recessed portions of first and second grippers in such a way that the spherical surface of the spherical journal is exposed;
arranging said preassembly in a cavity of a mold;
filling reinforcement fiber preform between said preassembly and the inner surface of said cavity;
mold-closing said mold and plunger so as to compress said reinforcement fiber preform in said mold;
molding said reinforcement fiber preform into a spherical bearing having a bearing surface that is spherically paired with the spherical surface of said spherical journal by impregnating the matrix in said reinforcement fiber preform that is compressed by mold-closing of said mold and plunger;
taking out said preassembly with the molded spherical bearing from the cavity of said mold by mold-opening of said mold and plunger; and
separating said first and second grippers from both ends of said spherical journal.

14. The method of claim 13, further comprising a step for coating the spherical surface of said spherical journal with metal coating before the step for preparing said preassembly.

15. The method of claim 14, further comprising a step for applying a self-lubricating layer on the surface of said metal coating.

16. The method of claim 13, wherein said step for preparing the preassembly comprises a step for fastening the nut to the bolt after passing the bolt through said first gripper, said spherical journal and said second gripper so as to clamp said spherical journal, said first gripper and said second gripper.

17. The method of claim 13, wherein said step for preparing the preassembly comprises a step in which the respective first and second axis portions are formed on both ends of said spherical journal, a first through hole is formed in the center of said first gripper to insert said first axis portion, and a second through hole is formed in the center of said second gripper to insert said second axis portion.

18. A method for manufacturing a spherical bearing assembly comprising the steps of:
preparing a preassembly by housing the edges on both ends of the a spherical journal in the respective recessed portions of first and second grippers in such a way that the spherical surface of the spherical journal is exposed;
attaching a fiber reinforced composite composed of a plurality of reinforced fibers and a matrix impregnated in these reinforced fibers to the spherical surface of said spherical journal and the respective outer surfaces of said first and second grippers;
mounting on the top surface of said lower mold a structure having an insert hole which can house said preassembly that has said fiber reinforced composite attached;
mounting on the top surface of said structure an upper mold having a cavity which can house said preassembly that has said fiber reinforced composite attached and a second guide hole into which the first gripper of said preassembly is inserted;
arranging said preassembly that has said fiber reinforced composite attached, in the lower cavity of said lower mold, through the cavity of said upper mold and an insert hole of said structure;
heating said matrix so as to have fluidity;
molding said fiber reinforced composite into a spherical bearing which has a bearing surface that is spherically paired with the spherical surface of said spherical journal and is inserted into the insert hole of said structure, by compressing said fiber reinforced composite on said upper mold by mold-closing of said mold and plunger;
taking out said preassembly, said spherical bearing and said structure from the cavity of said lower mold by mold-opening of said upper mold, said lower mold and said plunger; and
separating said first and second grippers from both ends of said spherical journal.

19. The method of claim 18, further comprising a step for coating the spherical surface of said spherical journal with metal coating before the step for preparing said preassembly.

20. The method of claim 19, further comprising a step for applying a self-lubricating layer on the surface of said metal coating.

21. The method of claim 18, wherein said step for preparing the preassembly comprises a step for fastening the nut to the bolt after passing the bolt through said first gripper, said spherical journal and said second gripper so as to clamp said spherical journal, said first gripper and said second gripper.

22. The method of claim 18, wherein said step for preparing the preassembly comprises a step in which the respective first and second axis portions are formed on both ends of said spherical journal, a first through hole is formed in the center of said first gripper to insert said first axis portion, and a second through hole is formed in the center of said second gripper to insert said second axis portion.

23. A method for manufacturing a spherical bearing assembly comprising the steps of:
preparing a preassembly by housing the edges on both ends of a spherical journal in the respective recessed portions of first and second grippers in such a way that the spherical surface of the spherical journal is exposed;
preparing a lower mold having a first guide hole into which the second gripper of said preassembly is inserted;
mounting on the top surface of said lower mold a structure having an insert hole which can house said preassembly;
mounting on the top surface of said structure an upper mold having a cavity which can house said preassembly and a second guide hole into which the first gripper of said preassembly is inserted;
arranging said preassembly in the lower cavity of said lower mold through the cavity of said upper mold and the hole of said structure;
filling reinforcement fiber preform between said preassembly, said cavity, said insert hole and said lower cavity;
compressing said reinforcement fiber preform in said upper mold by mold-closing of said mold and plunger; and
molding said reinforcement fiber preform into a spherical bearing having a bearing surface that is spherically paired with the spherical surface of said spherical journal by impregnating the matrix in said reinforcement fiber preform that is compressed by mold-closing of said upper mold and said plunger.

24. The method of claim 23, further comprising a step for coating the spherical surface of said spherical journal with metal coating before the step for preparing said preassembly.

25. The method of claim 24, further comprising a step for applying a self-lubricating layer on the surface of said metal coating.

26. The method of claim 23, wherein said step for preparing the preassembly comprises a step for fastening the nut to the bolt after passing the bolt through said first gripper, said spherical journal and said second gripper so as to clamp said spherical journal, said first gripper and said second gripper.

27. The method of claim 23, wherein said step for preparing the preassembly comprises a step in which the respective first and second axis portions are formed on both ends of said spherical journal, a first through hole is formed in the center of said first gripper to insert said first axis portion, and a second through hole is formed in the center of said second gripper to insert said second axis portion.
